(19) United States
(12) Patent Application Publication
(10) Pub. No.: US 2007/0147316 A1
(43) Pub. Date: Jun. 28, 2007

(54) Method and apparatus for communicating with a multi-mode wireless device

(75) Inventors: Shahid B. Khan, Tamarac, FL (US); Moises De La Cruz, Miami, FL (US); Edward L. Gilmore II, Sunrise, FL (US); Luis A. Pichardo, Miramar, FL (US); Glen S. Uehara, Gilbert, AZ (US); Albert L. Steele, Chandler, AZ (US)

Correspondence Address: FLEIT, KAIN, GIBBONS, GUTMAN, BONGINI;& BIANCO P.L., 551 N.W. 77TH STREET, SUITE 111, BOCA RATON, FL, 33487, US

(73) Assignee: MOTOROLA, INC., SCHAUMBURG, IL (US)

(21) Appl. No.: 11/316,354

(22) Filed: Dec. 22, 2005

(51) Int. Cl. H04Q 7/24

(52) U.S. Cl. 370/338

(57) ABSTRACT

A device, method, and system for communicating with at least one target wireless device are disclosed. The method includes initiating, by an originating wireless device (104), a communication using a first communication service with a target wireless device (106). The originating wireless device (104) determines that the target wireless device (106) is unavailable for the communication with the originating wireless device. In response to this determination, the originating wireless device (104) communicates with the target wireless device (106) by at initiating a communication using the second communication service with the second multi-mode wireless device (106); transmitting a voicemail message associated with the second multi-mode wireless (106) device using the second communication service; or transmitting a voice message using the first communication service, wherein the voice message is stored locally on the target wireless device (106).

### CROSS-REFERENCE TO RELATED APPLICATIONS

Not Applicable

### FIELD OF THE INVENTION

The present invention generally relates to the field of wireless communications devices, and more particularly relates to multi-mode wireless communication devices.

### BACKGROUND OF THE INVENTION

Currently, wireless communication devices such as cellular phones are capable of transmitting/receiving multiple communication services such as dispatch/push-to-talk (“PTT”) communications, interconnect/cellular communications, and data communications such as Voice Over IP (“VoIP”). For example, multi-mode devices using a multi-mode network can make both dispatch/PTT and interconnect/cellular calls. Dispatch/PTT is a method of conversing over half-duplex communication lines, including two-way radio, by pushing a button to send a transmission and releasing the button to receive a transmission back. In other words, dispatch/PTT allows a wireless communication device to operate as a two-way radio when in the dispatch/PTT mode. Only one dispatch/PTT user can transmit at a time but several users can receive the transmission at the same time.

More recently, push-to-talk over cellular (“PoC”) has become available to users of these multi-mode wireless communication devices. PoC is a wireless feature that allows wireless service subscribers to make direct, simultaneous radio voice connections over any packet data network. PoC is implemented on the IP back-bone, which allows any packet data service to provide PoC communications.

Although multi-mode wireless devices allow for two useful and different types of communications, these multi-mode wireless devices have numerous drawbacks, problems, and shortcomings.

One problem is that while a multi-mode wireless device is engaged in one communication service such as an interconnect/cellular call, the device cannot manage incoming calls from other communication services such as dispatch/PTT. For example, if the multi-mode wireless device is camped on two networks at the same time that offer two different communication services or camped on a single network offering two different communication services, an incoming dispatch call is not presented to the user when engaged in an interconnect call. In other words, the target device cannot respond to the incoming dispatch call. The originator of the dispatch call receives a signal indicating that the target is not available.

Therefore a need exists to overcome the problems with the prior art as discussed above.

### SUMMARY OF THE INVENTION

Briefly, in accordance with the present invention, disclosed are a method, device, and system for communicating with at least one target wireless device. The method includes initiating, by an originating wireless device, a communication using a first communication service with a target wireless device. The originating wireless device determines that the target wireless device is unavailable for the communication with the originating wireless device. In response to this determination, the originating wireless device communicates with the target wireless device by initiating a communication using the second communication service with the second multi-mode wireless device; transmitting a voicemail message associated with the second multi-mode wireless device using the second communication service; or transmitting a voice message using the first communication service, wherein the voice message is stored locally on the target wireless device.

In yet another embodiment of the present invention, a wireless communication system for communicating with at least one target wireless device. The wireless communication system comprises at least an originating wireless device and at least a target wireless device. The originating wireless device initiates a communication with the target multi-mode wireless device using a first communication service. The originating wireless device determines that the target wireless device is unavailable for the communication with the originating wireless device. The originating wireless device also communicates with the target multi-mode wireless device, in response to the target multi-mode wireless device being unavailable for the communication with the originating wireless device, by initiating a communication using the second communication service with the target multi-mode wireless device; transmitting a voicemail message associated with the second multi-mode wireless device using the second communication service; or transmitting a voice message using the first communication service, wherein the voice message is stored locally on the second multi-mode wireless device.

In yet another embodiment of the present invention, an originating wireless communication device for communication with a target wireless communication device wireless communication device is disclosed. The originating wireless communication device comprises a memory and a device controller electrically coupled to the memory. A a status determiner, communicatively coupled with the device controller, is also included for determining when a target wireless communication device is unavailable for the communication with the originating wireless device. The originating wireless device further includes a transmitter.

The transmitter is communicatively coupled with the device controller and is for at least initiating a first communication with a target wireless communication device using at least a first communication service and communicating with the target wireless communication device, in response to the target wireless device being unavailable for the communication with the originating wireless device, by initiating a second communication using the second communication service with the target wireless communication device; transmitting a voicemail message associated with the target wireless communication device using the second communication service; or transmitting a voice message using the first communication service, wherein the voice message is stored locally on the target wireless communication device.

An advantage of the present invention is that a wireless device communicating in a dispatch mode is notified when a target wireless device is in an interconnect call. The wireless device is then able to switch communication modes either automatically or manually to initiate an interconnect call to the target multi-mode device. Another advantage of the present invention is that the wireless device is able to leave a voice note for the target device, which is stored locally on the target device.

### BRIEF DESCRIPTION OF THE DRAWINGS

The accompanying figures where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is a block diagram illustrating a wireless communication system, according to an embodiment of the present invention;

FIG. 2 is a block diagram illustrating a multi-mode wireless device for a wireless communication system according to an embodiment of the present invention;

FIG. 3 is an operational flow diagram illustrating an exemplary process of switching from a dispatch mode to an interconnect mode when notified that a target multi-mode device is unavailable for the initiated communication, according to an embodiment of the present invention;

FIG. 4 is an operational flow diagram illustrating an exemplary process of responding to a signal indicating that a target multi-mode device is unavailable for the initiated communication, according to an embodiment of the present invention; and

FIG. 5 is an operational flow diagram illustrating another exemplary process of switching from a dispatch mode to an interconnect mode when notified that a target multi-mode device is unavailable for the initiated communication, according to an embodiment of the present invention.

### DETAILED DESCRIPTION

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language). The term coupled, as used herein, is defined as connected, although not necessarily directly, and not necessarily mechanically.

The present invention, according to an embodiment, overcomes problems with the prior art by notifying a multi-mode wireless originating a dispatch call that a target multi-mode wireless device is currently engaged in an interconnect call. The originating multi-mode wireless device is then able to switch communication modes and use an interconnect mode to communicate with the target multi-mode wireless device.

Although throughout the disclosure interconnect and dispatch communication services are used as the exemplary communication services, the present invention is not limited to such scenarios. For example, the present invention allows an originating wireless device to initiate a communication with a target wireless device using a first communication channel and detect if the target wireless device is currently active one a second communication channel. The originating wireless device can then switch communication modes. The communication modes can be dispatch, interconnect, private call, data (e.g. SMS, EMS, MMS, email, or the like), or any other type of communication mode or combination of communication modes as would be well known to one or ordinary skill in the art.

The term wireless device is intended to broadly cover many different types of devices that can wirelessly receive signals, and optionally can wirelessly transmit signals, and may also operate in a wireless communication system. For example, and not for any limitation, a wireless device can include any one or a combination of the following: a cellular telephone, a mobile phone, a smartphone, a two-way radio, a two-way pager, a wireless messaging device, a cordless phone, a device capable of wired communications such as via Public Switched Telephone Network and/or via another wired network such as a packet communication network, e.g. using Voice Over IP or other Internet communication protocols while also having wireless communication capability, and the like. The term multi-mode wireless device as used herein is intended to broadly cover any wireless device that can communicate using more than one wireless communication services such as dispatch (PTT/PoC), interconnect (cellular), data (SMS, EMS, MMS, Email, or the like) or any other type of communication service as would be well known to one or ordinary skill in the art. Additionally, as should be appreciated to those of ordinary skill in the art, the multi-mode wireless device can contemporaneously operate on one or more wireless networks.

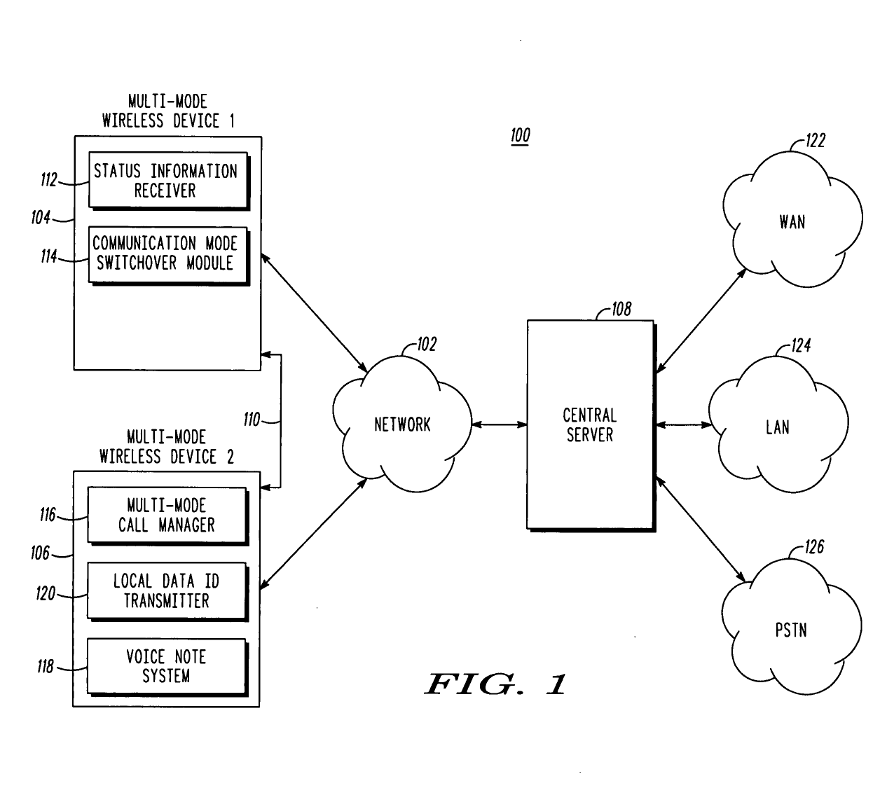

According to an embodiment of the present invention, as shown in FIG. 1, an exemplary wireless communications system 100 is illustrated. FIG. 1 shows a wireless communications network 102, that connects wireless devices such as multi-mode wireless devices 104, 106 and single-mode wireless devices (not shown) with a central server 108. The wireless network 102 comprises a mobile phone network, a mobile text messaging device network, a pager network, or the like. Further, the communications standard of the wireless network 102 of FIG. 1 comprises Code Division Multiple Access (CDMA), Time Division Multiple Access (TDMA), Global System for Mobile Communications (GSM), General Packet Radio Service (GPRS), Frequency Division Multiple Access (FDMA) or the like. Additionally, the wireless communications network 102 also comprises text messaging standards, for example, Short Message Service (SMS), Enhanced Messaging Service (EMS), Multimedia Messaging Service (MMS), or the like. The wireless communications network 102 also allows for PoC communications between the two multi-mode wireless devices 104, 106.

The wireless network 102 supports any number of multi-mode wireless devices 104, 106 and single-mode wireless devices (not shown). The support of the wireless network 102 includes support for mobile telephones, smart phones, text messaging devices, handheld computers, pagers, beepers, or the like. A smart phone is a combination of 1) a pocket PC, handheld PC, palm top PC, or Personal Digital Assistant (PDA), and 2) a mobile telephone. More generally, a smartphone can be a mobile telephone that has additional application processing capabilities.

Additionally, the multi-mode wireless devices 104, 106 also include an optional local wireless link 110 that allows the wireless devices 104, 106 to directly communicate with each other or with other multi-mode and single-mode wireless devices without using the wireless network 102. The optional local wireless link 110, for example, is provided by Bluetooth, Infrared Data Access (IrDA) technologies or the like.

In one embodiment, the multi-mode wireless device1 104 is an originating device and the multi-mode wireless device2 106 is a target device. For example, the multi-mode wireless device1 104 originates a dispatch call to a target multi-mode device such as the multi-mode wireless device2 106.

The multi-mode wireless1 104 includes a status information receiver 112 and a communication mode switchover module 114. The status information receiver 112 and communication mode switchover module 114 will be discussed in greater detail below. The multi-mode wireless device2 106 includes, in one embodiment, a multi-mode call manager 116 and an optional voice note system 118. The multi-mode call manager 116 manages incoming calls using a first communication service/communication mode while the multi-mode wireless device2 106 is in an active call using a second communication service/communication mode or vice-versa. The term incoming call used throughout this disclosure refers to, unless otherwise stated, an incoming call associated with a different communication service than what is currently being used by multi-mode wireless device. The term communication service is used interchangeably with the term communication mode throughout this disclosure.

In one embodiment, the multi-mode wireless device2 106 is currently using an interconnect mode and receives a dispatch call from the multi-mode wireless device1 104. The multi-mode call manager 116 transmits a unique signal to the originator of the dispatch call. The unique signal notifies the originator of the dispatch call such as the multi-mode wireless device1 104 that the multi-mode wireless device2 106 is currently engaged in an interconnect call. The optional voice note system 118 allows the multi-mode wireless device1 104 originating the dispatch call to leave a voice message locally on the target multi-mode wireless device2 106.

In another embodiment, an originating wireless device such as the multi-mode wireless device1 104 initiates a communication with the target wireless device and determines that the target wireless device is unavailable for the communication initiated by originating wireless device. In one embodiment the originating wireless device determines that the target wireless device is unavailable when the target wireless device is unable to be reached by the first communication service. For example, the target wireless device is unable to be reached by the first communication service when it is out of range for communicating by the first communication service, turned off, the first communication service is disabled for the target wireless device. The central server 108, in one embodiment, sends a signal to the originating wireless device indicating that the target device is unavailable. The originating wireless device can also detect that a time out has occurred after a period of time has passed without a response from the target device.

In another embodiment, the originating wireless device determines that the target wireless device is unavailable when the target wireless device is reachable, but unable to communicate using the first communication service. For example, if the target device is currently busy in an interconnect call, the originating device will receive a signal from the target device indicating that the target device is unavailable for the dispatch communication. In other embodiment, the target wireless device is able to communicate contemporaneously using two different communication services, and although reachable by the first communication service, the target wireless device is unavailable because it cannot process the incoming communication. The target device, in one embodiment, sends a signal to the originating devices indicating that the target device is unavailable for the communication initiated by the originating device.

The multi-mode wireless device2 106 also includes an optional local data ID transmitter 120. The local data ID transmitter 120 transmits information associated with the multi-mode wireless device2 106 such as caller ID information to another wireless device as described in the application “Real Time Caller Information Retrieval And Display In Dispatch Calls”, Ser. No. ______, now ______, which is commonly assigned herewith to Motorola, Inc. This related application is incorporated herein by reference in its entirety. Data ID, in another embodiment, is any type of data that can identify a specific wireless device such as a picture, multimedia, or the like, as would be understood to those of ordinary skill in the art.

For example, the local data ID transmitter 120 transmits caller ID information to the multi-mode wireless device1 104 when the multi-mode wireless device2 104 is engaged in an interconnect call and receives a dispatch call from the multi-mode wireless device1 104. The caller ID information allows the multi-mode wireless device1 104 to make an interconnect call to the multi-mode wireless device2 106 in response to receiving an engaged-in-interconnect-call notification signal. In another embodiment, the multi-mode wireless device1 104 uses information in its local contact database (not shown) to make an interconnect call to the multi-mode wireless device2 106 in response to the engaged-in-interconnect-call notification signal.

It is noted that each multi-mode wireless device 104, 106 is able to be an originator of a dispatch call and a target of a dispatch call while engaged in an interconnect call. Therefore, each multi-mode wireless device 104, 106 includes the status information receiver 112, communication mode switchover module 114, multi-mode call manager 116, optional voice note system 118, and the local data ID transmitter 118 in accordance with the present invention. The multi-mode wireless device1 104 and the multi-mode wireless device2 106 are not limited to their respective elements as shown in FIG. 1. Each multi-mode wireless device 104, 106 is shown in FIG. 1 to further illustrate which device is the originator of a dispatch call and the target of the dispatch call.

The central server 108 maintains and processes information for all wireless devices such as the multi-mode wireless devices 104, 106 communicating on the wireless network 102. Additionally, the central server 108, in this example, communicatively couples the multi-mode wireless devices 104, 106 and single-mode wireless devices (not shown) to a wide area network 122, a local area network 124, and a public switched telephone network 126 through the wireless communications network 102. Each of these networks 122 124, 126 has the capability of sending data, for example, a multimedia text message to the wireless devices 104, 106.

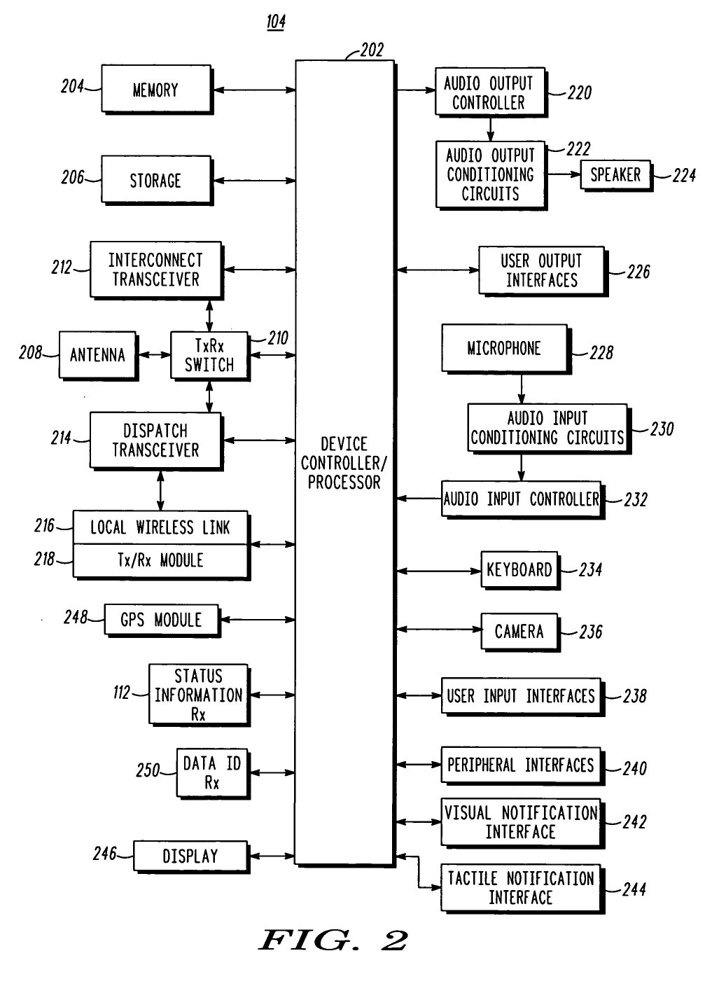

Referring to FIG. 2, a more detailed view of the multi-mode wireless device1 104 is illustrated. Although the following discussion is with respect to the multi-mode wireless device1 104, it is also applicable to the multi-mode wireless device2 106. The multi-mode wireless device1 104 operates under the control of a device controller/processor 202 that controls, among other things, the receiving and transmitting of dispatch and interconnect communications. Throughout this disclosure, interconnect mode is defined as being in a mode where normal full-duplex calls are made and not PTT of PoC calls.

In an interconnect receive mode, the device controller 202 electrically couples an antenna 208 through a transmit/receive switch 210 to an interconnect transceiver 212. The interconnect transceiver 212 decodes the received signals and provides those decoded signals to the device controller 202. In an interconnect transmit mode, the device controller 202 electrically couples the antenna 208, through the transmit/receive switch 210, to the interconnect transceiver 212. The interconnect transceiver 212, in one embodiment, also operates during a dispatch call to receive an interconnect signal from another wireless device. The device controller 202 operates the interconnect transceiver 212 according to instructions stored in the memory 204. These instructions include, for example, a neighbor cell measurement-scheduling algorithm.

In a dispatch receive mode the device controller 202 electrically couples an antenna 208 through a transmit/receive switch 210 to a radio transceiver 214. The radio transceiver 214 decodes the received signals and provides those decoded signals to the device controller 202. In a dispatch transmit mode, the device controller 202 electrically couples the antenna 208, through the transmit/receive switch 210, to the radio transceiver 214. The radio transceiver 214, in one embodiment, also operates during an interconnect call to receive a dispatch signal from another wireless device. The device controller 202 operates the radio transceiver 214 accordingly. In another embodiment, the cellular transceiver 212 and the radio transceiver 214 are a single component.

The multi-mode wireless device1 104 also includes the status information receiver 112. The status information receiver 112 receives a signal from a target multi-mode wireless device indicating that the target device is currently engaged in an interconnect call. For example, if the multi-mode wireless device1 104 initiates a dispatch call to a target multi-mode device and that device is currently in an interconnect call, the status information receiver 112 receives a signal from the target multi-mode device indicating its busy status. Although the status information receiver 112 is shown as a separate component in FIG. 2, in one embodiment, the status information receiver 112 resides in the interconnect transceiver 212, dispatch transceiver 214, or both.

The multi-mode wireless device1 104 also includes the communication mode switchover module 114 for seamlessly switching from a dispatch mode to an interconnect mode. For example, after initiating a dispatch call and receiving a signal from a target multi-mode device indicating that it is currently engaged in an interconnect call, the communication mode switchover module 114 switches the communication mode from a dispatch mode to an interconnect mode. In one embodiment, the communication mode switchover module 114 automatically switches from a dispatch mode to an interconnect mode and initiates an interconnect call to the target device.

In an alternative embodiment, the user of the multi-mode wireless device1 104 is prompted to decide whether to switch modes and initiate an interconnect call. Although the communication mode switchover module 114 is shown in FIG. 2 as a hardware component, in one embodiment, the communication mode switchover module is implemented by software. Although switching modes to an interconnect or dispatch mode is described, the present invention is not limited to these communication modes. For example, a data communication mode such as VoIP or any other data communication mode as is well known to one or ordinary skill in the art can also be used according to the embodiments of the present invention.

A data ID receiver 250 is also included in the multi-mode wireless device1 104. The data ID receiver 250 receives data ID such as caller ID information when transmitted by a target multi-mode wireless device. For example, when a target wireless device transmits a status signal to notify the device initiating a dispatch call that it is busy in an interconnect call, data ID information such as called ID information is also transmitted to the originating device so that it is able to make an interconnect call to the target device. The data ID information, in one embodiment, is transmitted with the status information signal. In another embodiment, the data ID information is transmitted as a separate signal to the originating device. Although the data ID information receiver 250 is shown as a separate component in FIG. 2, in one embodiment, the data ID information receiver 250 resides in the interconnect transceiver 212, dispatch transceiver 214, or both. In another embodiment, the data ID information receiver 250 is implemented as software residing in the non-volatile memory 206.

The multi-mode wireless device1 104 also includes non-volatile storage memory 206. The storage memory 206 retains, for example, an application waiting to be executed (not shown) on the multi-mode wireless device 104. The multi-mode wireless device 104, in this example, also includes an optional local wireless link 216 that allows the multi-mode wireless device 104 to directly communicate with another multi-mode wireless device 106 or a single-mode wireless device (not shown) without using the wireless network 102. When the dispatch mode is used to contact another multi-mode wireless unit, the local wireless link 216, for example, is provided by Mototalk and the radio transceiver 214 works in conjunction with the local wireless link 216. The local wireless link 216 includes a local wireless link transmit/receive module 218 that allows the multi-mode wireless device 104 to directly communicate with another multi-mode wireless device 106 or single subscriber wireless device by Bluetooth, Infrared Data Access (IrDA) technologies, or the like.

The multi-mode wireless device 104 of FIG. 2 further includes an audio output controller 220 that receives decoded audio output signals from the cellular transceiver 212, the radio transceiver 214, the local wireless link transmit/receive module 218. The audio controller 220 sends the received decoded audio signals to the audio output conditioning circuits 222 that perform various conditioning functions. For example, the audio output conditioning circuits 222 may reduce noise or amplify the signal. A speaker 224 receives the conditioned audio signals and allows audio output for listening by a user. The multi-mode wireless device 104 further includes additional user output interfaces 226, for example, a head phone jack (not shown) or a hands-free speaker (not shown).

The multi-mode wireless device 104 also includes a microphone 228 for allowing a user to input audio signals into the multi-mode wireless device 104. Sound waves are received by the microphone 228 and are converted into an electrical audio signal. Audio input conditioning circuits 230 receive the audio signal and perform various conditioning functions on the audio signal, for example, noise reduction. An audio input controller 232 receives the conditioned audio signal and sends a representation of the audio signal to the device controller 202.

The multi-mode wireless device 104 also comprises a keyboard 234 for allowing a user to enter information into the multi-mode wireless device 104. The multi-mode wireless device 104 further comprises a camera 236 for allowing a user to capture still images or video images into memory 204. Furthermore, the multi-mode wireless device 104 includes additional user input interfaces 238, for example, touch screen technology (not shown), a joystick (not shown), or a scroll wheel (not shown). In one embodiment, a peripheral interface 240 is included for allowing the connection of a data cable to the multi-mode wireless device 104. In one embodiment of the present invention, the connection of a data cable allows the multi-mode wireless device 104 to be connected to a computer or a printer.

A visual notification (or indication) interface 242 is also included on the multi-mode wireless device 104 for rendering a visual notification (or visual indication), for example, a sequence of colored lights on the display 246 or flashing one ore more LEDs (not shown), to the user of the multi-mode wireless device 104. For example, a received multimedia message may include a sequence of colored lights to be displayed to the user as part of the message. Alternatively, the visual notification interface 240 can be used as an alert by displaying a sequence of colored lights or a single flashing light on the display 246 or LEDs (not shown) when the multi-mode wireless device 104 receives a multimedia message, or the user missed a dispatch, interconnect call, or the like.

The multi-mode wireless device 104 also includes a tactile interface 244 for delivering a vibrating media component, tactile alert, or the like. For example, a multimedia message received by the multi-mode wireless device 104, may include a video media component that provides a vibration during playback of the multimedia message. The tactile interface 244, in one embodiment, is used during a silent mode of the multi-mode wireless device 104 to alert the user of an incoming call or message, missed call, or the like. The tactile interface 244 allows this vibration to occur, for example, through a vibrating motor or the like.

The multi-mode wireless device 104 also includes a display 246 for displaying information to the user of the multi-mode wireless device 104 and an optional Global Positioning System (GPS) module 248. The optional GPS module 248 determines the location and/or velocity information of the multi-mode wireless device 104. This module 248 uses the GPS satellite system to determine the location and/or velocity of the multi-mode wireless device 104. Alternative to the GPS module 248, the multi-mode wireless device 104 may include alternative modules for determining the location and/or velocity of multi-mode wireless device 104, for example, using cell tower triangulation, and assisted GPS.

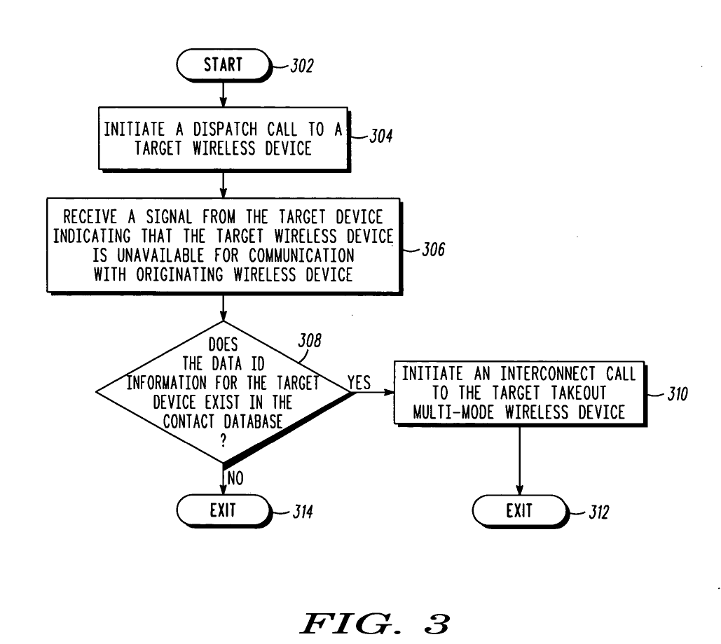

FIG. 3 is an operational flow diagram illustrating an exemplary process of switching communication modes in response to receiving a status signal indicating that a target multi-mode device is currently engaged in an interconnect call. The operational flow diagram of FIG. 3 begins with step 302 and flows directly to step 304. A user of the multi-mode wireless device1 104, at step 304, initiates a dispatch call to another multi-mode wireless device such as the multi-mode wireless device2 106. The multi-mode wireless device1 104, at step 306, receives a signal from the target multi-mode device indicating that the target multi-mode device is unavailable for the communication initiated by the originating wireless device. As discussed above with respect to FIG. 1, the target wireless device is unavailable when it is not able to be reached using a first communication service such as the dispatch service and/or when the target wireless device is reachable by the first communication service but is unable to communicate using the first communication service, e.g. the target wireless device is busy in a communication using a second communication service. The signal, in one embodiment, is received by the multi-mode wireless device1 104 on a voice channel. As a result of receiving the signal, the multi-mode wireless device1 104, at step 308, determines whether data ID information such as caller ID information for the target device exists in a contact database (not shown).

For example, the multi-mode wireless device1 104 searches the contact database (not shown) for the telephone number of the target multi-mode wireless device. In another embodiment, the target multi-mode device transmits its caller ID information to the multi-mode wireless device1 104 with the status signal. If the result of the determination at step 308 is positive, the multi-mode wireless device1 104 initiates an interconnect call to the target multi-mode wireless device. In one embodiment, the multi-mode wireless device1 104 automatically switches from a dispatch mode to an interconnect mode to initiate the interconnect call. In an alternative embodiment, the user is prompted, for example, by a message on the display 246 to initiate the interconnect call. In this embodiment, the user has the option of initiating the call or canceling the communication. The target multi-mode wireless device, for example, answers the interconnect call or alternatively, the interconnect call is transferred to the voicemail system of the target wireless device. The control flow then exits at step 312. If the result of the determination at step 308 is negative, the control flow then exits at step 314.

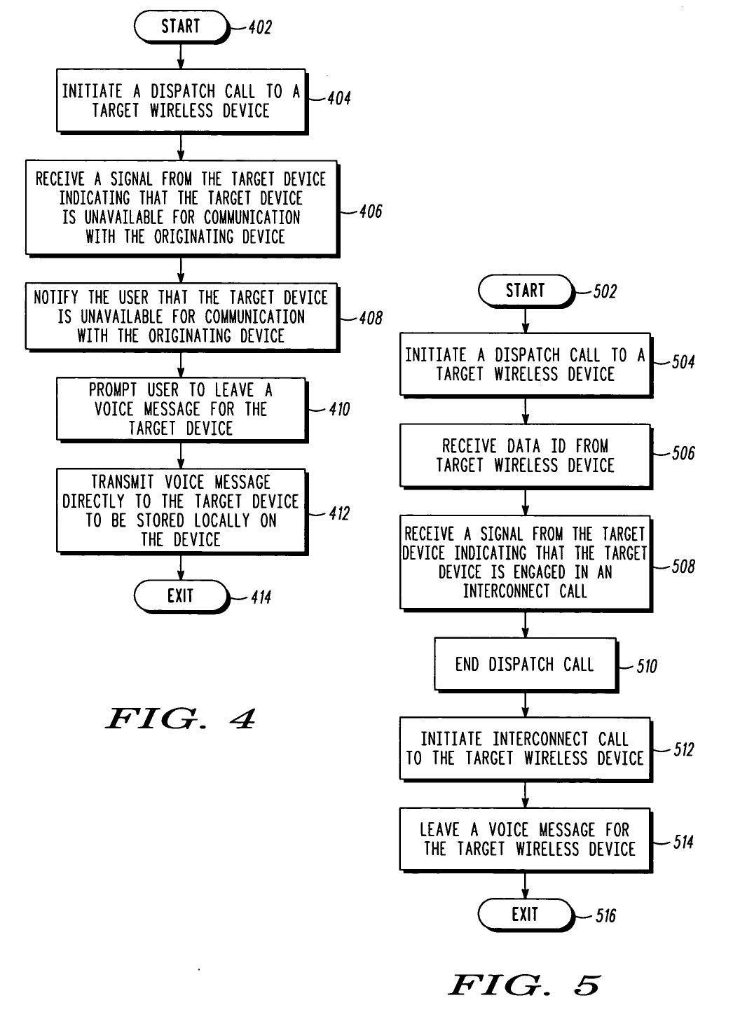

FIG. 4 is an operational flow diagram illustrating an exemplary process of responding to a received status signal indicating that the target multi-mode wireless device is currently engaged in an interconnect call. The operational flow diagram of FIG. 4 begins with step 402 and flows directly to step 404. A user of the multi-mode wireless device1 104, at step 404, initiates a dispatch call to another multi-mode wireless device such as the multi-mode wireless device2 106. The multi-mode wireless device1 104, at step 406, receives a status signal indicating that the target multi-mode device unavailable for the communication initiated by the originating device. In one embodiment, the signal is received by the multi-mode wireless device1 104 on a voice channel. The target wireless device, in one embodiment, transmits the status signal. In another embodiment, the central server 108 transmits the status signal.

As a result of receiving the signal, the multi-mode wireless device1 104, at step 408, notifies the user that the target multi-mode wireless device is unavailable for the initiated communication. As discussed above with respect to FIG. 1, the target wireless device is unavailable when it is not able to be reached using a first communication service such as the dispatch service and/or when the target wireless device is reachable by the first communication service but is unable to communicate using the first communication service, e.g. the target wireless device is busy in a communication using a second communication service. The user, at step 410, is prompted to leave a voicemail message for the target device. For example, in one embodiment, a message is displayed on the display 246 prompting the user to speak to leave a voice message. The voice message, at step 412, is transmitted directly to the target multi-mode device, for example, by using the dispatch mode. In one embodiment, the voice data is transmitted as the user is speaking. The target multi-mode wireless device stores the voice message locally, for example, in the voice note system 118. The control flow then exits at step 412.

FIG. 5 is an operational flow diagram illustrating another exemplary process of switching communication modes in response to receiving a signal that a target multi-mode device is currently engaged in an interconnect call. The operational flow diagram of FIG. 5 begins with step 502 and flows directly to step 504. A user of the multi-mode wireless device1 104, at step 504, initiates a dispatch call to a target multi-mode wireless device such as the multi-mode wireless device2 106. The multi-mode wireless device1 104, at step 506, receives data ID information from the target multi-mode wireless device2 106. For example, the multi-mode wireless device2 106 transmits its caller ID information on a voice channel to the target the multi-mode wireless device1 104.

Even though the target device is busy using a particular communication service, the target device can receive communications on a separate communication service. For example, when the target wireless device is in an interconnect call it can receive a communication using a dispatch mode, but the audio of the dispatch communication is ignored. The data ID information, in another embodiment, is information that allows the multi-mode wireless device1 104 to connect to the voicemail system of the target wireless device.

The multi-mode wireless device1 104, at step 508, receives a status signal from the target multi-mode wireless device indicating that the target multi-mode wireless device is currently engaged in an interconnect call. For example, in one embodiment, the signal is received by the multi-mode wireless device1 104 on a voice channel. The multi-mode wireless device1 104, at step 510, ends the dispatch call in response to receiving the status signal. The multi-mode wireless device1 104, at step 512, initiates an interconnect call to the target multi-mode wireless device. In one embodiment, the multi-mode wireless device1 104 uses caller ID information associated with the target device that is stored in a contact database (not shown) to initiate the interconnect call to the target multi-mode wireless device. In another embodiment, the multi-mode wireless device1 104 uses caller ID information received from the originating device to initiate the interconnect call. In another embodiment, the status signal triggers the multi-mode wireless device1 104 to automatically initiate the interconnect call to the target device. In an alternative embodiment, the user of the multi-mode wireless device1 104 is prompter to initiate the interconnect call.

The target multi-mode wireless device receives the interconnect call. The target multi-mode wireless device transfers the multi-mode wireless device1 104 to its voice mail. The user of the multi-mode wireless device1 104, at step 514, leaves a voicemail message, which is retained, for example, on the central server 108, for the target device. The control flow then exits at step 516.

An advantage of the present invention is that a multi-mode wireless device communicating in a dispatch mode is notified when a target multi-mode wireless device is in an interconnect call. The multi-mode wireless device is then able to switch communication modes either automatically or manually to initiate an interconnect call to the target multi-mode device. Another advantage of the present invention is that the multi-mode wireless device is able to leave a voice message for the target device, which is stored locally on the target device.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A method for communicating with at least one target wireless device, the method on an originating wireless device comprising:
initiating, by an originating wireless device, a communication with a target wireless device, the communication using a first communication service;
determining, by the originating wireless device, that the target wireless device is unavailable for the communication with the originating wireless device; and
communicating with the target wireless device, in response to determining that the target wireless device is unavailable for the communication with the originating wireless device, by:
initiating a communication using the second communication service with the target wireless device;
transmitting a voicemail message associated with the target wireless device using the second communication service; or
transmitting a voice message using the first communication service, wherein the voice message is stored locally on the target wireless device.

2. The method of claim 1, wherein the first communication service is a dispatch service and the second communication service is an interconnect service.

3. The method of claim 1, further comprising:
receiving a signal from the target wireless device, the signal indicating that the target wireless device is unavailable for the communication with the originating wireless device.

4. The method of claim 1, wherein initiating the communication using the second communication service further comprises:
automatically initiating the communication using the second communication service in response to the target wireless device being unavailable for the communication with the originating wireless device.

5. The method of claim 1, wherein initiating the communication using the second communication service further comprises:
prompting a user of the originating wireless device to initiate the communication using the second communication service in response to the target wireless device being unavailable for the communication with the originating wireless device.

6. The method of claim 1, further comprising:
receiving data ID information from the target wireless device; and
using the data ID information received from the target wireless device to initiate the communication using the second communication service with the target wireless device.

7. The method of claim 1, further comprising:
searching a contact database for caller ID information associated with the target wireless device; and,
using the caller ID information associated with the target wireless device to initiate the communication using the second communication service with the target wireless device.

8. The method of claim 1, wherein the determining, by the originating wireless device, that the target wireless device is unavailable further comprises:
determining that the target wireless device is unable to be reached using the first communication service.

9. The method of claim 1, wherein the determining, by the originating wireless device, that the target wireless device is unavailable further comprises:
determining that the target wireless device is able to be reached using the first communication service but is busy and unable to communicate using the first communication service.

10. A wireless communication system for communicating with at least one target wireless device, the wireless communication system comprising:
at least an originating wireless device and at least a target wireless device, wherein the originating wireless device:
initiates a communication with the target wireless device, the communication using a first communication service;
determines that the target wireless device is unavailable for the communication with the originating wireless device; and
communicates with the target wireless device, in response to the target wireless device being unavailable for the communication with the originating wireless device, by:
initiating a communication using the second communication service with the target wireless device;
transmitting a voicemail message associated with the target wireless device using the second communication service; or
transmitting a voice message using the first communication service, wherein the voice message is stored locally on the target wireless device.

11. The wireless communication system of claim 10, wherein the first communication service is a dispatch service and the second communication service is an interconnect service.

12. The wireless communication system of claim 10, wherein the originating wireless device receives a signal from the target wireless device, the signal indicating that the target wireless device is unavailable for the communication with the originating wireless device.

13. The wireless communication system of claim 10, wherein the originating wireless device automatically initiates the communication using the second communication service in response to the target wireless device being unavailable for the communication with the originating wireless device.

14. The wireless communication system of claim 10, wherein originating wireless device prompts a user of the originating wireless device to initiate the communication using the second communication service in response to the target wireless device being unavailable for the communication with the originating wireless device.

15. The wireless communication system of claim 10, wherein the originating wireless device receives data ID information from the target wireless device and uses the data ID information received from the target wireless device to initiate the communication using the second communication service with the target wireless device.

16. An originating wireless communication device for communication with a target wireless communication device, the originating wireless communication device comprising:
a memory;
a device controller electrically coupled to the memory;
a status determiner, communicatively coupled with the device controller, for determining when a target wireless communication device is unavailable for the communication with the originating wireless device; and
a transmitter, communicatively coupled with the device controller, for at least initiating a first communication with a target wireless communication device using at least a first communication service and communicating with the target wireless communication device, in response to determining that the target wireless communication device is unavailable for the communication with the originating wireless device, by:
initiating a second communication using the second communication service with the target wireless communication device;
transmitting a voicemail message associated with the target wireless communication device using the second communication service; or
transmitting a voice message using the first communication service, wherein the voice message is stored locally on the target wireless communication device.

17. The originating wireless communication device of claim 16, wherein the first communication service is a dispatch service and the second communication service is an interconnect service.

18. The originating wireless communication device of claim 16, further comprising:
a status information receiver for receiving a signal from the target wireless communication device, the signal indicating that the target wireless communication device is unavailable for the communication with the originating wireless device.

19. The originating wireless communication device of claim 16, wherein initiating the communication using the second communication service further comprises:
automatically initiating the communication using the second communication service in response to the target wireless communication device being unavailable for the communication with the originating wireless device.

20. The originating wireless communication device of claim 16, wherein the initiating the communication using the second communication service further comprises:
prompting a user of the originating wireless communication device to initiate the communication using the second communication service in response to the target wireless communication device being unavailable for the communication with the originating wireless device.

21. The wireless communication device of claim 16, further comprising:
a data ID receiver for receiving data ID information from the target wireless communication device or a wireless communication server, wherein the transmitter uses the data ID information received from the target wireless communication device or the wireless communication server to initiate the communication using the second communication service with the target wireless communication device.

22. The originating wireless communication device of claim 16, further comprising:
a caller ID information searcher for searching a contact database for caller ID information associated with the target wireless device, wherein the transmitter uses the caller ID information associated with the target wireless communication device to initiate the communication using the second communication service with the target wireless communication device.
